(19) United States
(12) Patent Application Publication
(10) Pub. No.: US 2024/0029195 A1
(43) Pub. Date: Jan. 25, 2024

(54) IMAGE PROCESSING DEVICE AND IMAGE PROCESSING METHOD

(71) Applicant: SK hynix Inc., Icheon-si Gyeonggi-do (KR)

(72) Inventors: Satoru Saito, Icheon-si Gyeonggi-do (KR); Kazuhiro Yahata, Icheon-si Gyeonggi-do (KR)

(73) Assignee: SK hynix Inc., Icheon-si Gyeonggi-do (KR)

(21) Appl. No.: 18/100,944

(22) Filed: Jan. 24, 2023

(30) Foreign Application Priority Data
Jul. 21, 2022 (KR) 10-2022-0090029

(51) Int. Cl. G06T 1/60; G06T 3/40; G06T 5/00

(52) U.S. Cl. CPC G06T 1/60; G06T 3/4015; G06T 5/006; G06T 2207/10024; H04N 23/843

(57) ABSTRACT

The present technology relates to an image processing device. The image processing device according to the present technology may include a buffer configured to parallelize pixel data of an image that is received from an external device based on the number of horizontal direction pixels that are used for a distortion interpolation operation and configured to store the parallelized pixel data in line memories, and a distortion interpolator configured to read interpolation data that are used for the distortion interpolation operation among the pixel data that are stored in the line memories based on coordinate information of a target pixel, which is a distorted pixel, and configured to perform the distortion interpolation operation based on the interpolation data.

### CROSS-REFERENCE TO RELATED APPLICATION

The present application claims priority under 35 U.S.C. § 119(a) to Korean patent application number 10-2022-0090029, filed on Jul. 21, 2022, in the Korean intellectual Property Office, the entire disclosure of which is incorporated herein by reference.

### BACKGROUND

### 1. Technical Field

The present disclosure relates to an image processing device, and more particularly, to an image processing device and an image processing method.

### 2. Related Art

An image processing device may improve quality of an image by performing an image processing operation. The image processing device may interpolate distortion that is generated due to an optical characteristic of a lens using peripheral pixel values. In order to perform a distortion interpolation operation, pixel data including peripheral pixel values is required. The image processing device may temporarily store the pixel data of the image and perform the distortion interpolation operation.

As the amount of pixel data that is temporarily stored in the image processing device decreases, storage efficiency may be improved. The image processing device may reduce the amount of temporarily stored data by storing only pixel data for a portion of an image that is used for performing the distortion interpolation operation.

A position stored in a line memory may indicate a position of pixels in the image. The image processing device may reduce the amount of temporarily stored data by storing the pixel data in line memories.

### SUMMARY

According to an embodiment of the present disclosure, an image processing device may include a buffer configured to parallelize pixel data of an image that is received from an external device based on the number of horizontal direction pixels that are used for a distortion interpolation operation and configured to store the parallelized pixel data in line memories, and a distortion interpolator configured to read interpolation data that are used for the distortion interpolation operation among the pixel data that are stored in the line memories based on coordinate information of a target pixel, which is a distorted pixel, and configured to perform the distortion interpolation operation based on the interpolation data.

According to an embodiment of the present disclosure, an image processing method may include image that is received, storing the pixel data in line memories, the pixel data parallelized base0007d on a pixel unit that is determined according to the number of horizontal direction pixels of a line memory, reading interpolation data that are used for a distortion interpolation operation, among the pixel data that are stored in the line memories, based on coordinate information of a target pixel, which is a distorted pixel, and performing the distortion interpolation operation based on the interpolation data.

### BRIEF DESCRIPTION OF THE DRAWINGS

FIG. 1 is a diagram illustrating an image processing device according to an embodiment of the present disclosure.

FIG. 2 is a diagram illustrating a distortion interpolation operation according to an embodiment of the present disclosure.

FIG. 3 is a diagram illustrating the maximum number of distortion lines that are required for a distortion interpolation operation according to an embodiment of the present disclosure.

FIG. 4 is a diagram illustrating the minimum number of line memories according to an embodiment of the present disclosure.

FIG. 5 is a diagram illustrating a method of storing pixel data in line memories according to an embodiment of the present disclosure.

FIG. 6 is a diagram illustrating a method of generating position information of interpolation data according to an embodiment of the present disclosure.

FIG. 7 is a diagram illustrating a method of storing pixel data in line memories according to an embodiment of the present disclosure.

FIG. 8 is a diagram illustrating a method of reading pixel data that are stored in a line memory according to a first horizontal coordinate according to an embodiment of the present disclosure.

FIG. 9 is a diagram illustrating a method of reading interpolation data from line memories according to an embodiment of the present disclosure.

FIG. 10 is a diagram illustrating a method of performing a distortion interpolation operation according to an embodiment of the present disclosure.

FIG. 11 is a diagram illustrating speed conversion of a clock signal according to an embodiment of the present disclosure.

FIG. 12 is a diagram illustrating a Bayer pattern of a color filter array.

FIG. 13 is a diagram illustrating a demosaicing component according to an embodiment of the present disclosure.

FIG. 14 is a diagram illustrating a demosaicing operation according to an embodiment of the present disclosure.

FIG. 15 is a diagram illustrating a method of generating interpolation data of a red pixel according to an embodiment of the present disclosure.

FIG. 16 is a diagram illustrating a method of generating interpolation data of a blue pixel according to an embodiment of the present disclosure.

FIG. 17 is a flowchart illustrating a method of performing a distortion interpolation operation according to an embodiment of the present disclosure.

FIG. 18 is a diagram illustrating an image processing device according to another embodiment of the present disclosure.

FIG. 19 is a block diagram illustrating an electronic device including an image processing device according to an embodiment of the present disclosure.

### DETAILED DESCRIPTION

Specific structural or functional descriptions of embodiments according to the concept which are disclosed in the present specification or application are illustrated only to describe the embodiments according to the concept of the present disclosure. The embodiments according to the concept of the present disclosure may be carried out in various forms and should not be construed as being limited to the embodiments described in the present specification or application.

Hereinafter, in order to describe the disclosure in detail enough that a person of ordinary skill in the art to which the present disclosure pertains may easily implement the technical spirit of the present disclosure, an embodiment of the present disclosure is described with reference to the accompanying drawings.

An embodiment of the present disclosure provides an image processing device and an image processing method for storing pixel data for a portion of an image in line memories and reading interpolation data from the line memories to perform a distortion interpolation operation.

According to the present technology, an image processing device and an image processing method that minimize an amount of pixel data that are stored in a line memory and perform a distortion interpolation operation by quickly reading interpolation data from the line memories may be provided.

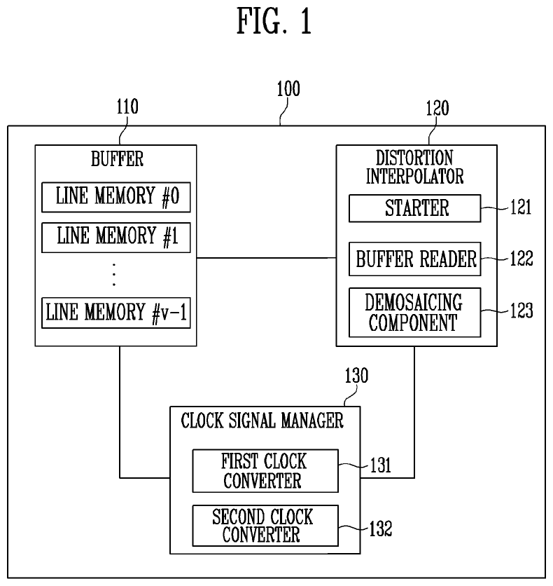

FIG. 1. is a diagram illustrating an image processing device according to an embodiment of the present disclosure.

Referring to FIG. 1, the image processing device 100 may receive and temporarily store pixel data and may perform a distortion interpolation operation based on the pixel data. The image processing device 100 may include a buffer 110, a distortion interpolator 120, and a dock signal manager 130.

The buffer 110 may parallelize pixel data of an image that is received from an external device based on the number of horizontal direction pixels that are used for the distortion interpolation operation. The buffer 110 may store the parallelized pixel data in line memories.

The buffer 110 may include the line memories. The number of line memories may exceed an addition of twice the maximum number of distortion lines of the image and half the number of lines that are used for the distortion interpolation operation.

The buffer 110 may determine a pixel unit that is stored in the line memories based on the number of horizontal direction pixels. The buffer 110 may sequentially store the pixel data in the line memories according to the pixel unit.

In response to all of the line memories being full, the buffer 110 may store additional data in a line memory, among the line memories, storing the oldest data. The buffer 110 may operate in a cyclical structure in which the oldest data that are stored in the line memories are deleted so that the additional data may be stored.

The distortion interpolator 120 may read interpolation data that are used for the distortion interpolation operation, among the pixel data that are stored in the line memories, based on coordinate information of a target pixel, which is a distorted pixel. The distortion interpolator 120 may perform the distortion interpolation operation based on the interpolation data.

The distortion interpolator 120 may include a starter 121 that generates a start signal that triggers the distortion interpolation operation based on an amount of data that is stored in the line memories and a buffer reader 122 that generates position information, which indicates a position of the interpolation data that are stored in the line memories.

The starter 121 may output the start signal in response to the fact that the number of line memories, among the line memories, storing the pixel data, is equal to the addition of twice the maximum number of distortion lines related to the target pixel and half the number of lines that are used for the distortion interpolation operation. The start signal may include coordinate information of the target pixel.

The buffer reader 122 may generate the position information indicating the position of the interpolation data that are stored in the line memories based on a display coordinate of the target pixel and a distortion coordinate of the target pixel in response to reception of the start signal. The position information may include a vertical coordinate indicating a line memory in which the interpolation data is stored in the line memories and a horizontal coordinate indicating a horizontal direction coordinate in which the interpolation data is stored in the line memory. The horizontal coordinate may include a first horizontal coordinate indicating a horizontal direction coordinate of the target pixel in the line memory and a second horizontal coordinate indicating a position at which pixel data for the target pixel is stored among pixel data for a plurality of pixels that are stored in the first horizontal coordinate according to the pixel unit.

The buffer reader 122 may generate read data, including pixel data of which a horizontal coordinate is the same as the interpolation data, from each of the line memories based on the first horizontal coordinate. The buffer reader 122 may obtain intermediate data corresponding to the vertical coordinate from the read data. The buffer reader 122 may select the interpolation data from the intermediate data based on the second horizontal coordinate and output the interpolation data.

In an embodiment of the present disclosure, the distortion interpolation operation that is performed by the distortion interpolator 120 may be a bilinear interpolation operation. In response to the bilinear interpolation operation, the read data may include pixel data for a plurality of pixels that are stored at a position, indicated by the first horizontal coordinate and a coordinate adjacent to the first horizontal coordinate. The intermediate data may include read data that are stored in line memories, indicated by the vertical coordinate and a coordinate adjacent to the vertical coordinate among the read data. The interpolation data may include pixel data for pixels, indicated by the second horizontal coordinate and a coordinate adjacent to the second horizontal coordinate among the intermediate data.

The image processing device 100 may further include the clock signal manager 130 that applies a first clock signal used for the distortion interpolation operation to the distortion interpolator 120 and applies a second clock signal that is at least two times faster than the first clock signal to the buffer 110. The clock signal manager 130 may include a first clock converter 131 that increases a speed of the clock signal by a speed of the second clock signal and a second clock converter 132 that decreases the speed of the second clock signal by the speed of the first clock signal.

In an embodiment of the present disclosure, the first clock converter 131 may increase a clock speed for the position information. The second clock converter 132 may decrease a clock speed for the interpolation data.

In an embodiment of the present disclosure, in response to the fact that the distortion interpolation operation that is performed by the distortion interpolator 120 is the bilinear interpolation operation, the second dock signal may be faster than the first dock signal by twice. The speed difference between the dock signals may vary according to a type of the distortion interpolation operation that is performed by the distortion interpolator 120.

In an embodiment of the present disclosure, the buffer reader 122 may generate weighted value information that is used for the distortion interpolation operation based on a distortion value, indicating a difference between the display coordinate of the target pixel and the distortion coordinate of the target pixel. The distortion interpolator 120 may correct a result of the distortion interpolation operation based on the weighted value information.

The buffer reader 122 may generate position information based on an integer part of the distortion value. The buffer reader 122 may generate the weighted value information based on a fractional part of the distortion value. The weighted value information may include each of horizontal direction weighted value information and vertical direction weighted value information. The buffer reader 122 may delay an output of the weighted value information and output the weighted value information at the same timing as the interpolation data.

In an embodiment of the present disclosure, the buffer reader 122 may input the generated weighted value information to the dock signal manager 130 to delay the output. The buffer reader 122 may delay a timing of the output of the weighted value information by using an additional delayer. The weighted value information for target pixel and the interpolation data may be simultaneously output. The distortion interpolator 120 may perform the distortion interpolation operation based on the weighted value information and the interpolation data.

In an embodiment of the present disclosure, the distortion interpolator 120 may further include a demosaicing component 123 that changes a color of pixels included in the interpolation data to be the same. The demosaicing component 123 may determine a color of pixels of the interpolation data based on the display coordinate and the position information. The demosaicing component 123 may change pixel data for a position of pixels having a color that is different from that of the target pixel in the interpolation data to pixel data of pixels having the same color as the target pixel.

The demosaicing component 123 may include a first demosaicing component that changes pixel data for a red pixel or a blue pixel to pixel data for a green pixel, and a second demosaicing component that changes the pixel data for the green pixel to the pixel data for the red pixel or the blue pixel. In an embodiment of the present disclosure, a method of changing the pixel data for the green pixel to the pixel data for the red pixel and a method of changing the pixel data for the green pixel to the pixel data for the blue pixel are different only in terms of positions and the method of changing may be the same. Since a pixel data change for the red pixel and the blue pixel is performed in the second demosaicing component, a size of the demosaicing component changing the pixel data may be reduced.

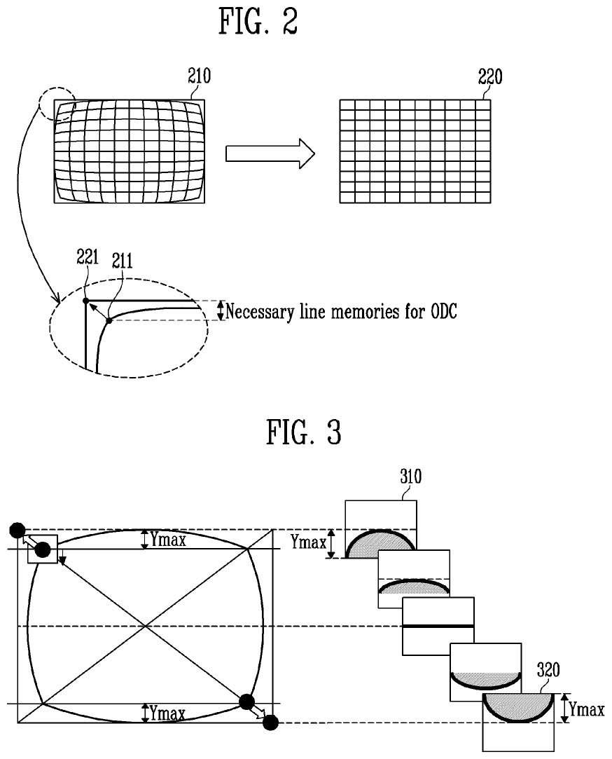

FIG. 2 is a diagram illustrating a distortion interpolation operation according to an embodiment of the present disclosure.

Referring to FIG. 2, an image 210 that is distorted due to an optical characteristic of a lens may be interpolated into a normal image 220 through the distortion interpolation operation. In FIG. 2, a barrel-shaped distortion in which distortion occurs at an edge of the image may be shown. However, this is only an embodiment, and the present disclosure is not limited thereto.

In order to interpolate the distorted image 210 into the normal image 220, the pixel data of the image is required. For example, the image processing device may perform the distortion interpolation operation based on pixel data between a distortion coordinate 211 and a normal coordinate 221. An amount of the pixel data that are required may vary according to the degree of distortion of the image. The distortion of the image may become more severe toward the edge of the image.

FIG. 3 is a diagram illustrating the maximum number of distortion lines that are required for a distortion interpolation operation according to an embodiment of the present disclosure.

Referring to FIG. 3, a case in which distortion becomes more severe toward the edge of the image may be shown. Specifically, the distortion may be most severe at the edge of the image. In FIG. 3, It may be assumed that the pixel data of the image is sequentially stored in the line memory from an upper portion to a lower portion.

The number of lines 310 that are required to interpolate distortion that is generated at the uppermost end of the image and the number of lines 320 required to interpolate distortion that is generated at the lowermost end of the image may be greater than the number of lines required to interpolate distortion that is generated at another position of the image. The number of lines 310 and 320 that are required to interpolate the distortion that is generated at the uppermost end and the lowermost end may be the same in FIG. 3.

The pixel data of the image may be divided into a plurality of lines. The pixel data that are required to interpolate the distortion that is generated in the image may be pixel data that are positioned at an upper end or pixel data that are positioned at a lower end based on a pixel in which the distortion occurs. Specifically, a position in which the pixel data that are required for the distortion interpolation are stored may vary according to a type of the generated distortion. Pixel data that are stored later than the distortion pixel may be required to interpolate the distortion that is generated at the uppermost end of the image, and pixel data that are stored before the distortion pixel may be required to interpolate the distortion that is generated at the lowermost end of the image. In order to interpolate all types of distortion occurring at an arbitrary position, the number of pixel data that are required to be stored in the buffer may be at least two times greater than the maximum number of distortion lines that are required for the distortion interpolation operation based on the distortion pixel.

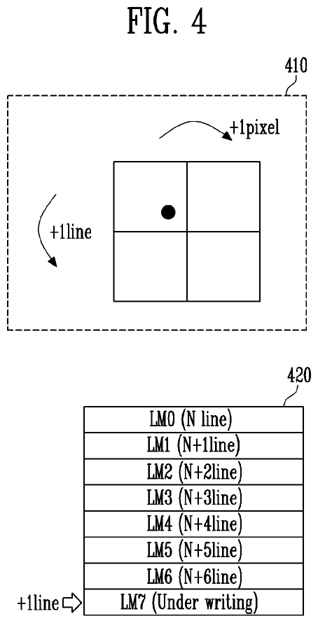

FIG. 4 is a diagram illustrating the minimum number of line memories according to an embodiment of the present disclosure.

Referring to FIG. 4, the minimum number of line memories that are required for the interpolation operation may vary according to the type of the interpolation operation and a writing method to the line memory.

In an embodiment of the present disclosure, a bilinear interpolation operation 410 may be performed. The bilinear interpolation operation may be performed by using pixel data of a total of four pixels in which one pixel is added in a horizontal direction, one pixel is added in a vertical direction, and one pixel is added in a diagonal direction compared to a distortion pixel. In response to the performance of the bilinear interpolation operation 410, the number of line memories that are required for the distortion interpolation operation may be increased by one.

In an embodiment of the present disclosure, data that are stored in the line memory on which a write operation is being performed might not be used for the distortion interpolation operation (420). A line memory for performing the write operation is required to be additionally secured. The number of line memories that are required for the distortion interpolation operation may be increased by one corresponding to the write operation of the line memory.

According to the description of FIGS. 3 and 4, the minimum number of line memories for performing the distortion interpolation operation may be the number that is obtained by adding 1 to the addition of twice the maximum number of distortion lines of the image and half the number of lines used for the distortion interpolation operation. The number of line memories that are included in the buffer may be more than (the addition of twice the maximum number of distortion lines of the image and half the number of lines used for the distortion interpolation operation)+1.

In another embodiment of the present disclosure, line memories capable of simultaneously performing a write operation and a read operation may be included in the buffer. Since interpolation data may be read from the line memory on which the write operation is being performed, the number of line memories required for the distortion interpolation operation might not be increased. In this case, the minimum number of line memories for performing the distortion interpolation operation may be equal to the addition of twice the maximum number of distortion lines of the image and half the number of lines used for the distortion interpolation operation.

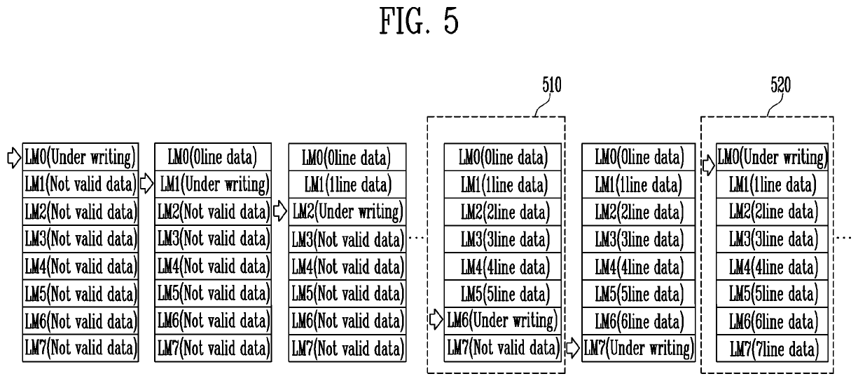

FIG. 5 is a diagram illustrating a method of storing pixel data in line memories according to an embodiment of the present disclosure.

Referring to FIG. 5, the pixel data may be sequentially stored in eight line memories. It may be assumed that the maximum number of distortion lines is two, and the number of lines that are required for interpolation processing is three.

Since the minimum number of line memories capable of performing the distortion interpolation operation is 7 (4+2+1), the distortion interpolation operation may be performed.

The starter may generate the start signal that triggers the distortion interpolation operation based on the amount of data that is stored in the line memories. When the number of line memories in which the pixel data is stored becomes 6, which is the addition of twice the maximum number of distortion lines (4) and half the number of lines that are required for the interpolation processing ( 3/2->2), the starter may generate the start signal (510). The buffer reader may generate the position information that indicates the position of the interpolation data that are stored in the line memories based on the display coordinate of the target pixel and the distortion coordinate of the target pixel.

Even after the start signal is generated, the pixel data may be sequentially stored in the line memories. When the pixel data is stored in all eight line memories, additional pixel data may be stored (520) in line 0 memory in which the pixel data was first stored. At this time, the pixel data that are previously stored in a line 0 memory may be deleted. The line memories may form a cyclical structure, and the pixel data that are stored in the line memories may be read and used for the distortion interpolation operation.

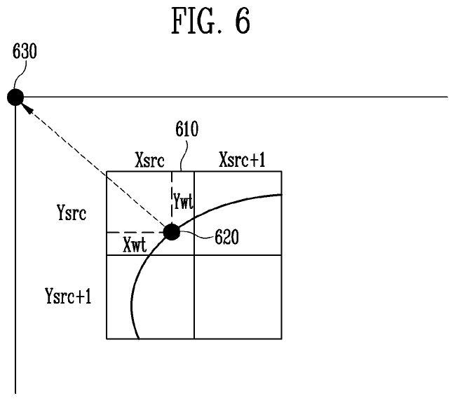

FIG. 6 is a diagram illustrating a method of that generates position information of interpolation data according to an embodiment of the present disclosure.

Referring to FIG. 6, the distortion interpolator may generate position information indicating a position of the interpolation data that are stored in the line memories based on a display coordinate 630 of a target pixel 610 and a distortion coordinate 620 of the target pixel 610. When the distortion interpolation operation is performed, the distortion coordinate 620 may be moved to the display coordinate 630. The distortion coordinate 620 may be a coordinate including a decimal point rather than an integer coordinate.

The position information may be generated based on an integer part of the distortion coordinate 620 of the target pixel 610. The position information may include a horizontal coordinate Xsrc and a vertical coordinate Ysrc of the target pixel 610. The horizontal coordinate Xsrc may indicate a horizontal direction coordinate in which the interpolation data is stored in a line memory, among line memories, storing non-parallelized pixel data. The vertical coordinate Ysrc may indicate a line memory in which the interpolation data is stored.

The buffer reader may generate the weighted value information that is used for the distortion interpolation operation based on a distortion value, indicating a difference between the display coordinate 630 and the distortion coordinate 620. The weighted value information may be generated based on the fractional part of the distortion value.

In an embodiment of the present disclosure, the interpolation data that are required for the distortion interpolation operation may be interpolation data for four pixels in response to the performance of the bilinear interpolation operation, Specifically, the target pixel 610, a pixel that is horizontally adjacent to the target pixel 610, a pixel that is vertically adjacent to the target pixel 610, and a pixel that is diagonally adjacent to the target pixel 610 may be the interpolation data. The weighted value information for correcting a result of the distortion interpolation operation may include horizontal weighted value information Xwt and vertical weighted value information Ywt. The distortion interpolation operation may be performed on the target pixel 610 based on the interpolation data of the four pixels, and the result of the distortion interpolation operation may be corrected based on the weighted value information Xwt and Ywt.

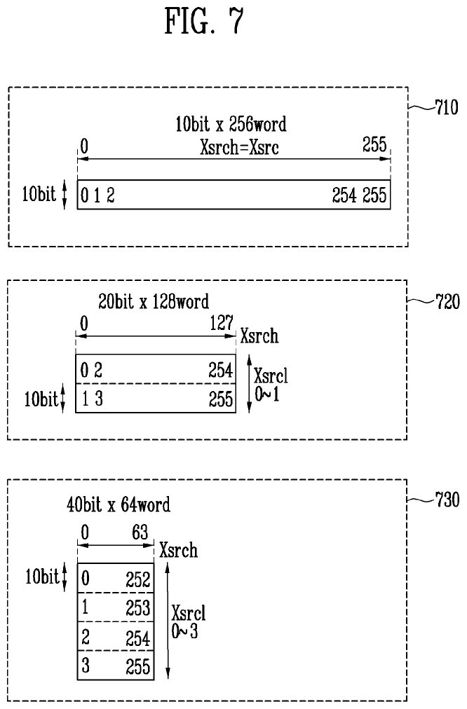

FIG. 7 is a diagram illustrating a method of storing pixel data in line memories according to an embodiment of the present disclosure.

Referring to FIG. 7, the parallelized pixel data may be stored in the line memories. The numbers of horizontal pixels of the line memory in which the same amount of pixel data is stored may be different from each other. In FIG. 7, it may be assumed that pixel data for 256 pixels is stored in one line memory, and 10 bit data is allocated to one pixel.

When the pixel data is not parallelized, the number of horizontal pixels of the line memory may be 256 (710). At this time, a pixel unit of read/write data may be one pixel, and a first horizontal coordinate Xsrch indicating the horizontal direction coordinate of the target pixel in the line memory may be 0 to 255. The first horizontal coordinate Xsrch may be the same as the horizontal coordinate Xsrc of the target pixel that is included in the position information.

The pixel data may be parallelized in two pixel units and stored in the line memories (720). The first horizontal coordinate Xsrch of the pixel data for the 256 pixels may be 0 to 127. The first horizontal coordinate Xsrch may be a value that is excluded from a least significant bit by the number of bits corresponding to the pixel unit from the horizontal coordinate Xsrc of the target pixel that is included in the position information.

For example, it may be assumed that the horizontal coordinate Xsrc of the target pixel is 8. When the horizontal coordinate Xsrc of the target pixel is expressed in binary, the horizontal coordinate Xsrc of the target pixel is 1000(2), and 100(2) that is obtained by excluding one bit corresponding to the pixel unit from a least significant bit from 1000(2) may become the first horizontal coordinate Xsrch. At this time, a second horizontal coordinate Xsrcl, indicating a position at which the pixel data for the target pixel is stored, among the pixel data for the plurality of pixels that are stored in the same first horizontal coordinate, according to the pixel unit, may become 0, which is a value corresponding to the least significant bit. The second horizontal coordinate Xsrcl may be 0 or 1.

In another embodiment of the present disclosure, the pixel data may be parallelized in four pixel unit and stored in the line memories (730), The first horizontal coordinate Xsrch of the pixel data for the 256 pixels may be 0 to 63. As the pixel unit increases, the number of pixels that are stored in the same first horizontal coordinate Xsrch may increase.

For example, it may be assumed that the horizontal coordinate Xsrc of the target pixel is 8. When the horizontal coordinate Xsrc of the target pixel is expressed in binary, the horizontal coordinate Xsrc of the target pixel may be 1000(2), and 10(2) that is obtained by excluding two bits corresponding to the pixel unit from a least significant bit from 1000(2) may become the first horizontal coordinate Xsrch. At this time, the second horizontal coordinate Xsrcl may be 00(2), which is a value corresponding to the two least significant bits. The second horizontal coordinate Xsrcl may be 0 to 3.

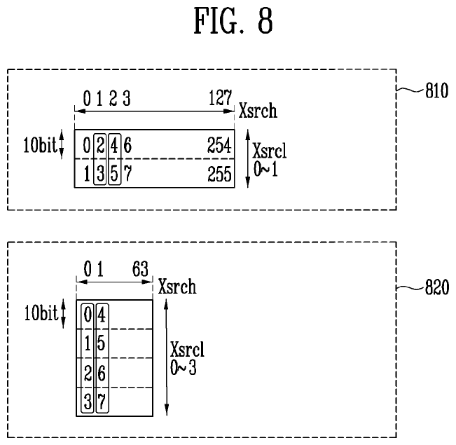

FIG. 8 is a diagram illustrating a method of reading pixel data that are stored in a line memory according to a first horizontal coordinate according to an embodiment of the present disclosure.

Referring to FIG. 8, the buffer reader may read the interpolation data that are stored in the line memories based on the position information. The buffer reader may read the pixel data of pixels corresponding to the first horizontal coordinate from each of the line memories.

In FIG. 8, the target pixel may be shaded, and the pixels that are read from the line memory may be boxed. In FIG. 8, it may be assumed that the distortion interpolation operation may be a bilinear operation.

When the pixel unit is to pixels and the horizontal coordinate Xsrc of the target pixel is 11(2), the pixel data that are read from the line memory may be shown (810). The first horizontal coordinate Xsrch corresponding to the horizontal coordinate Xsrc is 1(2), and the second horizontal coordinate Xsrcl is 1(2). The buffer reader may read pixel data of pixels that are stored in a position corresponding to 1 and 2 of the first horizontal coordinate Xsrch, in response to the fact that the first horizontal coordinate Xsrch is 1.

Specifically, the buffer reader may read pixel data corresponding to 2, 3, 4, and 5 of the horizontal coordinate Xsrc based on the first horizontal coordinate Xsrch. The buffer reader may read the pixel data corresponding to 2, 3, 4, and 5 of the horizontal coordinate Xsrc from each of the line memories.

When the pixel unit is four pixels and the horizontal coordinate Xsrc of the target pixel is 11(2), the pixel data that are read from the line memory may be shown (820). The first horizontal coordinate Xsrch corresponding to the horizontal coordinate Xsrc is 0, and the second horizontal coordinate Xsrcl is 11(2). The buffer reader may read pixel data of pixels that are stored in a position corresponding to 0 and 1 of the first horizontal coordinate Xsrch in response to the fact that the first horizontal coordinate Xsrch is 0.

The buffer reader may read pixel data corresponding to 0, 1, 2, 3, 4, 5, 6, and 7 of the horizontal coordinate Xsrc based on the first horizontal coordinate Xsrch. The buffer reader may read the pixel data corresponding to 0, 1, 2, 3, 4, 5, 6, and 7 of the horizontal coordinate Xsrc from each of the line memories.

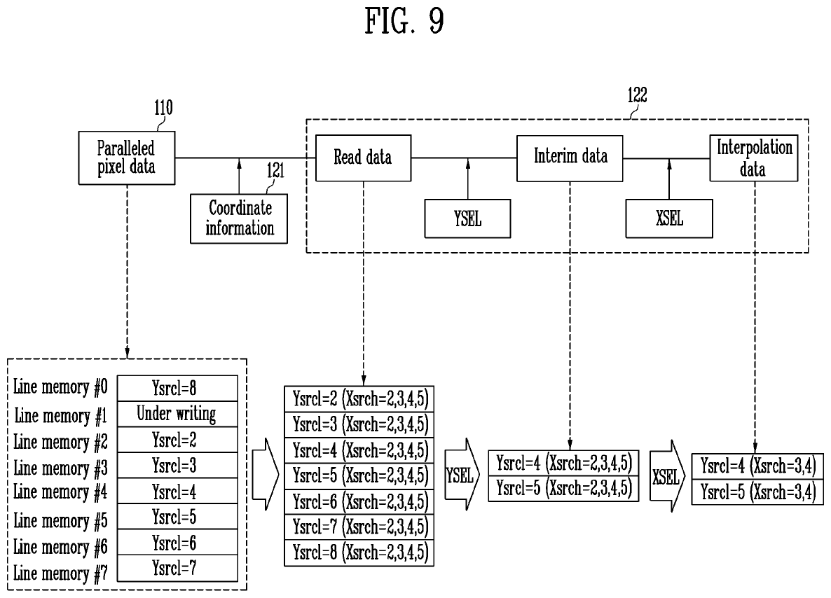

FIG. 9 is a diagram illustrating a method of reading interpolation data from line memories according to an embodiment of the present disclosure.

Referring to FIG. 9, the interpolation data may be obtained from the pixel data that are stored in the line memories. In FIG. 9, a dotted arrow may indicate each of the parallelized pixel data, the read data, the intermediate data, and the interpolation data as a figure.

Among the line memories, a total of eight line memories from number 0 to number 7 may be included in the buffer 110. The parallelized pixel data may be stored in the buffer 110. The parallelized pixel data may be stored in each of the line memories that are included in the buffer 110.

The starter 121 may transmit the start signal, including the coordinate information of the target pixel, to the buffer reader 122. The buffer reader 122 may read the read data, including the interpolation data, from the buffer 110.

In response to the start signal that is received from the starter 121, the buffer reader 122 may read the read data corresponding to the first horizontal coordinate Xsrch from each of the line memories. Since the number 1 line memory is in a write operation, the pixel data may be read from the remaining line memories, except for the first line memory. In FIG. 9, it may be assumed that the bilinear distortion interpolation operation is performed, the horizontal coordinate Xsrc of the target pixel indicates 3, and the vertical coordinate Ysrcl of the target pixel indicates number 4 line memory.

The buffer reader 122 may read the interpolation data, including the pixel data for the four pixels that are used to perform the bilinear distortion interpolation operation, from the line memories. Specifically, the buffer reader 122 may read read data corresponding to 2, 3, 4, and 5 of the first horizontal coordinate Xsrch from each of the remaining line memories except for the number 1 line memory.

Two line memories may be selected in response to the bilinear distortion interpolation operation. The buffer reader 122 may select (YSEL) the intermediate data from the read data based on the vertical coordinate Ysrcl. In FIG. 9, the buffer reader 122 may obtain the intermediate data that are stored in the number 4 line memory and the number 5 line memory based on the vertical coordinate Ysrcl from the read data.

The buffer reader 122 may select (XSEL) the interpolation data from the intermediate data based on the second horizontal coordinate Xsrcl. In FIG. 9, the buffer reader 122 may extract pixel data of which the horizontal coordinate Xsrc is 3 and 4, among pixel data of which the horizontal coordinate Xsrc is 2, 3, 4, and 5, based on the second horizontal coordinate Xsrcl. The interpolation data that are read by the buffer reader from the line memories may be the pixel data of which horizontal coordinate Xsrc is 3 and 4, included in the number 4 and number 5 line memories.

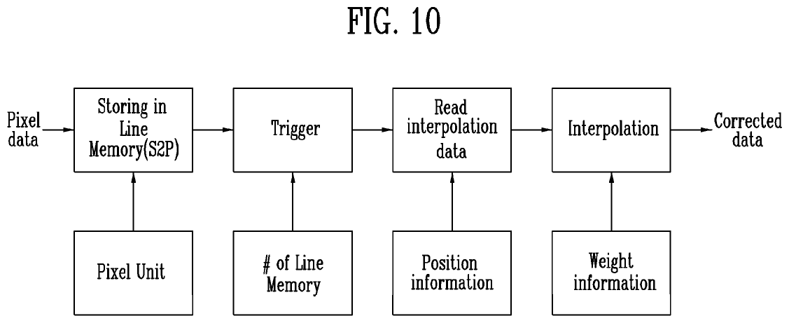

FIG. 10 is a diagram illustrating a method of performing a distortion interpolation operation according to an embodiment of the present disclosure.

Referring to FIG. 10, the image processing device may receive the pixel data and output correction data that are obtained by performing the distortion interpolation operation based on the received pixel data.

The buffer may parallelize the pixel data on the pixel unit and store the parallelized pixel data in the line memories. The number of horizontal pixels that are used for the distortion interpolation operation may vary according to the pixel unit. The number of pixels that are stored in a position in which the first horizontal coordinate is the same may increase in response to an increase of the pixel unit. When the pixel unit is increased, an X coordinate range of the line memory may be narrowed.

An operation in which the buffer parallelizes the pixel data and stores the parallelized pixel data in the line memories may correspond to the description of FIG. 7.

The starter may generate the start signal that triggers the distortion interpolation operation based on the number of line memories that are storing the pixel data. The starter may output the start signal when the pixel data is stored in the line memories of the number equal to the addition of twice the maximum number of distortion lines related to the target pixel and half the number of lines used for the distortion interpolation operation.

The description of the trigger of the distortion interpolation operation may correspond to the description of FIGS. 3, 4, and 5.

The buffer reader may read the interpolation data that are stored in the line memories based on the position information. The pixel data that are required for the interpolation data may vary according to the distortion interpolation operation. The buffer reader may read the read data from the line memories based on the first horizontal coordinate and determine the line memories in which the interpolation data is stored based on the vertical coordinate. The buffer reader may extract the interpolation data, among the pixel data of which the first horizontal coordinate is the same, based on the second horizontal coordinate related to the pixel unit.

A description of the interpolation data that are read may correspond to the description of FIGS. 6, 8, and 9.

The distortion interpolator may perform the distortion interpolation operation based on the interpolation data. The distortion interpolator may generate the weighted value information based on the fractional part included in the distortion coordinate of the target pixel. The distortion interpolator may correct the result of the distortion interpolation operation based on the weighted value information. The weighted value information may be output simultaneously with the interpolation information that is related to the weighted value information. In order to adjust an output timing of the weighted value information, a separate delayer may be further included in the distortion interpolator.

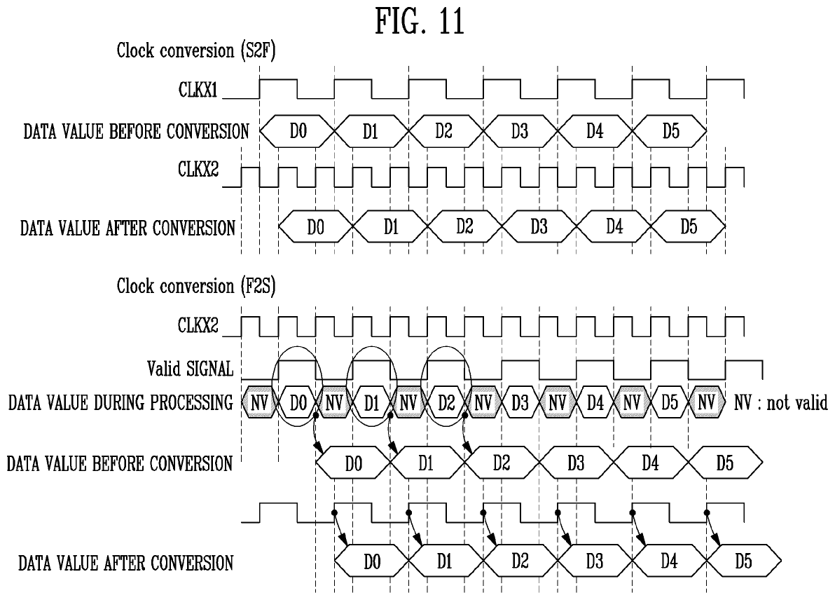

FIG. 11 is a diagram illustrating speed conversion of a dock signal according to an embodiment of the present disclosure.

Referring to FIG. 11, the speed of the clock signal may be changed. Even when a clock speed is changed, a data value might not be changed. The clock signal of which the speed is changed may be delayed from the clock signal before the speed is changed.

The speed of the clock signal may be changed quickly (slow to fast) or slowly (fast to slow) through a clock signal converter. As the speed of the clock signal increases, data that are transmitted through the clock signal may increase.

In an embodiment of the present disclosure, a speed of a clock signal that transmits information related to a position may be variously changed according to transmitted information. The interpolation data that are required for the distortion interpolation operation may include pixel data of a distortion pixel and a peripheral pixel of the distortion pixel, A clock signal that transmits information related to the interpolation data and a clock signal that transmits the interpolation data may have a speed of a clock signal that is faster than a clock signal that is used to perform the distortion interpolation operation.

In response to the performance of the bilinear distortion interpolation operation, the interpolation data may include pixel data for a pixel that is increased by 1 in a horizontal and vertical direction of the distortion pixel. The dock signal for transmitting the interpolation data may be at least two times faster than the clock signal for the distortion interpolation operation. The speed of the dock signal transmitting the interpolation data may be increased according to an amount of interpolation data. After the distortion interpolator outputs the interpolation data, the speed of the dock signal may be decreased.

A dock signal of which a speed of a signal is changed regardless of the speed of the clock signal may be delayed. In an embodiment of the present disclosure, the weighted value information that may be generated together with position information generation may be output together with the interpolation data. The weighted value information may be delayed during a certain period and then output after the weighted value information is generated. In order to delay the output of the weighted value information, a separate delayer may be included in the distortion interpolator or the speed of the clock signal may be changed to delay the output timing of the weighted value information.

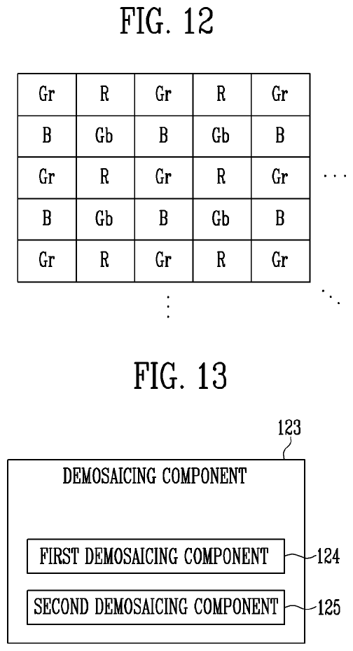

FIG. 12 is a diagram illustrating a Bayer pattern of a color filter array.

Referring to FIG. 12, pixels included in a pixel array of an image sensor may be one of a green pixel, a red pixel, and a blue pixel. In FIG. 12, one Bayer pattern, among patterns in which colors of pixels are arranged, is shown.

The Bayer pattern may be configured of a repetition of 2×2 patterns. In the Bayer pattern, green color filters Gb and Gr may be disposed in a diagonal manner, and a blue color filter B and a red color filter R may be disposed at the remaining corners. The four color filters B, Gb, Gr, and R are not necessarily limited to the structural arrangement of FIG. 12 and may be variously disposed.

FIG. 13 is a diagram illustrating a demosaicing component according to an embodiment of the present disclosure.

Referring to FIG. 13, the interpolation data includes pixel data for pixels of which the colors are the same. In order to perform the distortion interpolation operation, pixel data of peripheral pixels of which a color is the same as the distortion pixel may be required. In an embodiment of the present disclosure, it may be assumed that the pixels of the image sensor are the Bayer pattern.

When the color of the pixels is the Bayer pattern, the interpolation data may include pixel data for different colors. Pixel data for pixels of which colors are different may be required to be changed to the pixel data for the pixels having the same color.

The demosaicing component 123 may determine the colors of the pixels of the interpolation data based on the display coordinate and the position information. Colors of neighboring pixels may be different from each other according to the Bayer pattern in which the colors of the pixels are arranged. The demosaicing component 123 may change pixel data for a position of pixels having a color that is different from that of the target pixel, among the interpolation data, to pixel data of pixels having the same color as the target pixel.

The demosaicing component 123 may include a first demosaicing component 124 that changes pixel data for a red pixel or a blue pixel to pixel data for a green pixel, and a second demosaicing component 125 that changes the pixel data for the green pixel to the pixel data for the red pixel or the blue pixel. Since a relatively large number of green pixels are disposed around the red pixel and the blue pixel in the Bayer pattern, the first demosaicing component 124 may change pixel data of pixels of which colors are different, included in the interpolation data, based on pixel data of adjacent pixels.

Conversely, since relatively few red pixels and blue pixels may be arranged around the green pixels in the Bayer pattern, the second demosaicing component 125 may change the pixel data by using pixel data of pixels that are close to a pixel of which a color is changed.

In an embodiment of the present disclosure, a demosaicing operation of changing the interpolation data to the pixel data for the red color or the blue color may be performed by the second demosaicing component 125. A relative position of the red pixel or the blue pixel with respect to the green pixel in the Bayer pattern may be matched through symmetrical movement. Therefore, both the operation of changing the pixel data for the green pixel to the pixel data for the red pixel and the operation of changing the pixel data for the green pixel to the pixel data for the blue pixel may be performed by the second demosaicing component 125.

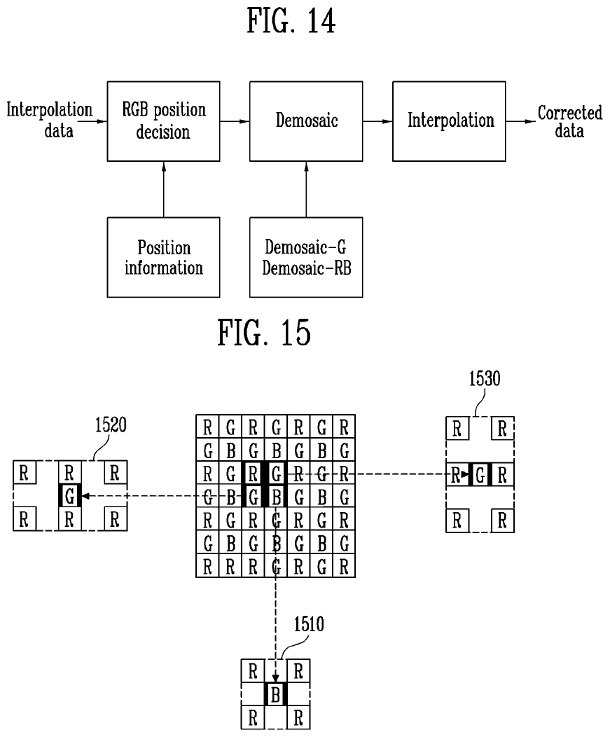

FIG. 14 is a diagram illustrating a demosaicing operation according to an embodiment of the present disclosure.

Referring to FIG. 14, the interpolation data may be changed to the interpolation data for the pixels of which the color is the same through the demosaicing operation, and the interpolation operation may be performed based on the interpolation data.

In order to perform the interpolation operation, the color of the pixels of the interpolation data that are used for the interpolation operation may be required to be the same. When a color pattern in the pixel array is the Bayer pattern, the color of the pixels that are included in the interpolation data may be required to be changed. In an embodiment of the present disclosure, assuming that a bilinear distortion correction operation is performed, the interpolation data may be pixel data of four adjacent pixels. In the Bayer pattern, since all colors of pixel data of a 2×2 format might not be the same, the colors of the pixels that are included in the interpolation data may be required to be changed to be the same.

The demosaicing component may determine the color of the pixels based on the position information. The demosaicing component may determine the color corresponding to the interpolation data based on the display coordinate and the position information of the target pixel. The demosaicing component may change the pixel data so that all colors of the interpolation data are the same by using neighboring pixel data of the interpolation data.

The demosaicing component may change the color of the interpolation data to green. The demosaicing component may change the color of the interpolation data to blue or red. A method of changing the color of the interpolation data to green and a method of changing the color of the interpolation data to blue or red may be different from each other, Since the pixels of the image are arranged along the Bayer pattern, regarding the method of changing the color of the interpolation data to blue and the method of changing the color of the interpolation data to red, a method of calculating pixel data in which a position of used pixel data is symmetrical and changed may be the same.

The distortion interpolator may perform the distortion interpolation operation based on the interpolation data that are changed to the pixel data for the same color. The image processing device may read the interpolation data that are necessary for the distortion interpolation operation without storing information regarding the entire image. The demosaicing component may change the interpolation data to the pixel data of the pixels having the same color. The distortion interpolator may output the interpolation data by performing the distortion interpolation operation based on the interpolation data on which the demosaicing operation is performed.

FIG. 15 is a diagram illustrating a method of that generates interpolation data of a red pixel according to an embodiment of the present disclosure.

Referring to FIG. 15, it may be assumed that the interpolation data is displayed in a shade in response to the performance of the bilinear distortion correction operation, and a color arrangement of the pixels corresponds to the Bayer pattern.

The red pixel, among the interpolation data that are displayed in the shade, may be maintained as it is. The blue pixel, among the interpolation data, may be changed to an average value of four red pixels adjacent in a diagonal direction (1510). The green pixel, among the interpolation data, may be changed to an average value of two adjacent red pixels, a pixel of which a color is changed, and four red pixels that are spaced apart from each other in a diagonal direction (1520 and 1530).

In an embodiment of the present disclosure, pixel data of the green pixels may be changed based on an average value or a median value of six red pixels. The demosaicing component may change the pixel data through a weighted value addition of assigning a weighted value to two red pixels adjacent to the green pixel.

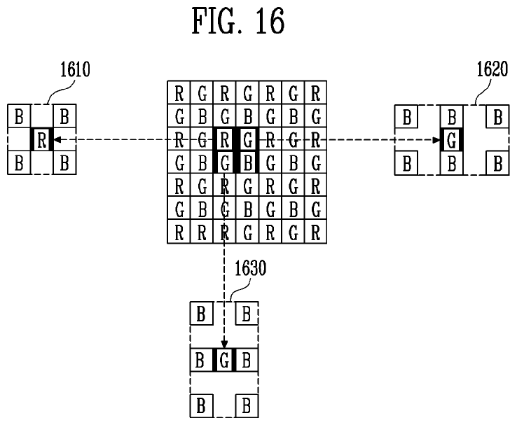

FIG. 16 is a diagram illustrating a method of that generates interpolation data of a blue pixel according to an embodiment of the present disclosure.

Referring to FIG. 16, it may be assumed that the interpolation data is displayed in a shade in response to the performance of the bilinear distortion correction operation, and a color arrangement of the pixels corresponds to the Bayer pattern.

The blue pixel, among the interpolation data that are displayed in the shade, may be maintained as it is. The red pixel, among the interpolation data, may be changed to an average value of four blue pixels adjacent in a diagonal direction (1610). The green pixels, among the interpolation data, may be changed to an average value of two adjacent blue pixels, a pixel of which a color is changed, and four blue pixels that are spaced apart from each other in a diagonal direction (1620 and 1630).

As shown in FIGS. 15 and 16, it may be seen that positions of the interpolation data are the same, positions of the pixels on which the demosaicing operation is performed are symmetrical in the red pixel and the blue pixel, and a calculation process is the same. Therefore, the operation of changing the pixel data for the green pixel to the pixel data for the blue pixel or the red pixel may be performed by the second demosaicing component. According to an embodiment of the present disclosure, since the demosaicing component corresponding to the red pixel and the blue pixel may be shared, a logic scale may be decreased and a processing speed may be improved compared to an imaging processing device including a demosaicing component corresponding to the green pixel, a demosaicing component corresponding to the blue pixel, and a demosaicing component corresponding to the red pixel.

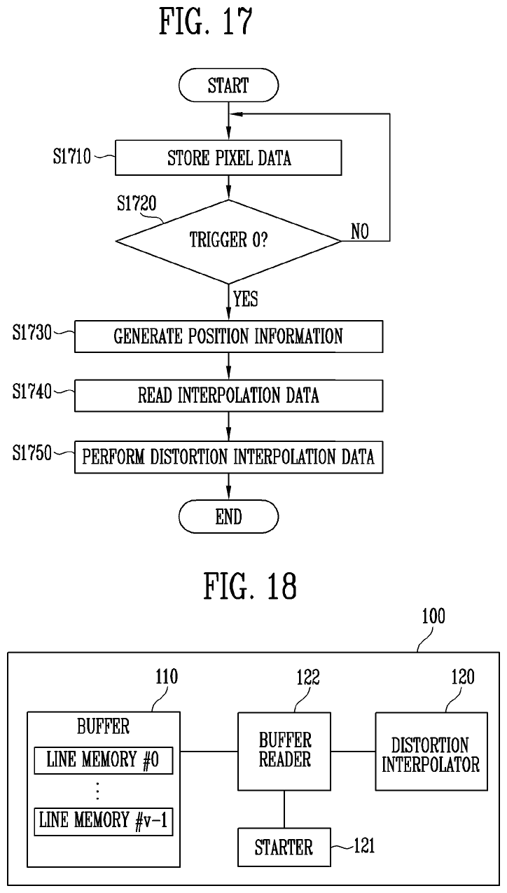

FIG. 17 is a flowchart illustrating a method of performing a distortion interpolation operation according to an embodiment of the present disclosure.

Referring to FIG. 17, the image processing device might not use a frame memory by storing the pixel data in the line memories. The position in which the pixel data is stored in the line memory may indicate the position of the pixel in the image. According to an embodiment of the present disclosure, storage efficiency of the buffer and performance of the distortion interpolation operation may be improved.

In step S1710, the buffer may parallelize the pixel data and store the parallelized pixel data in the line memories. The number of line memories may exceed the addition of twice the maximum number of distortion lines of the image and half the number of lines that are used for the distortion interpolation operation. The buffer may determine the pixel unit for parallelizing the pixel data based on the number of horizontal direction pixels of the line memory.

In step S1720, the starter may determine whether to trigger the distortion interpolation operation. The starter may generate and output the start signal of the distortion interpolation operation according to an amount of the pixel data that are stored in the line memories. The starter may generate the start signal when the number of line memories storing the pixel data is equal to or greater than the addition of twice the maximum number of distortion lines related to the target pixel and half the number of lines that are used for the distortion interpolation operation. When the number of line memories storing the pixel data is less than the addition, the parallelized pixel data may be continuously stored.

In step S1730, the buffer reader may generate the position information indicating the position of the interpolation data that are stored in the line memories based on the display coordinate of the target pixel and the distortion coordinate of the target pixel. In an embodiment of the present disclosure, the position information may be generated based on the integer part of the distortion coordinate of the target pixel.

In step S1740, the buffer reader may read the interpolation data that are used for the distortion interpolation operation from the line memories based on the position information. The buffer reader may generate the read data from each of the line memories based on the first horizontal coordinate, indicating the horizontal direction coordinate of the target pixel. The buffer reader may obtain the intermediate data corresponding to the vertical coordinate, indicating the line memory in which the interpolation data is stored, among the line memories, from the read data. The buffer reader may output the interpolation data from the intermediate data based on the second horizontal coordinate, indicating the position at which the pixel data for the target pixel is stored, among the pixel data, for the plurality of pixels that are stored in the first horizontal coordinate.

In step S1750, the distortion interpolator may perform the distortion interpolation operation based on the interpolation data. The distortion interpolator may simultaneously obtain the weighted value information that is generated based on the fractional part of the distortion coordinate of the target pixel, together with the interpolation data. The distortion interpolator may correct the result of the distortion interpolation operation based on weighted value information.

FIG. 18 is a diagram illustrating an image processing device according to another embodiment of the present disclosure.

Referring to FIG. 18, the image processing device 100 may be variously configured in addition to the structure shown in FIG. 1. The image processing device 100 may include a buffer 110, a starter 121, a buffer reader 122, and a distortion interpolator 120.

Differently from FIG. 1., the starter 121 and the buffer reader 122 might not be included in the distortion interpolator 120. In FIG. 18, a position of the starter 121 and the buffer reader 122 is merely exemplary, and the starter 121 and the buffer reader 122 may be variously configured inside the image processing device 100, For example, only the starter 121 may be included in the distortion interpolator 120, or only the buffer reader 122 may be included in the distortion interpolator 120. In another embodiment of the present disclosure, differently from that shown in FIG. 18, the starter 121 may be included in the buffer.

The buffer 110 may parallelize the pixel data of the image that is received from the external device and store the parallelized pixel data in the line memories. The buffer 110 may transmit information on the number of line memories that store the pixel data to the starter 121.

The starter 121 may generate the start signal that triggers the distortion interpolation operation in response to the fact that the number of line memories storing the pixel data exceeds a predetermined value. The starter 121 may transmit the start signal to the buffer reader 122.

The buffer reader 122 may read the interpolation data that are used for the distortion interpolation operation from the buffer 110. The buffer reader 122 may generate the position information, indicating the position in which the interpolation data is stored, based on the display coordinate of the target pixel and the distortion coordinate of the target pixel. The buffer reader 122 may transmit the read interpolation data to the distortion interpolator 120.

The distortion interpolator 120 may perform the distortion interpolation operation based on the interpolation data. In an embodiment of the present disclosure, the distortion interpolator 120 may perform the bilinear interpolation operation to remove distortion included in the image.

The image processing device 100 may further include the clock signal manager 130 of FIG. 1.

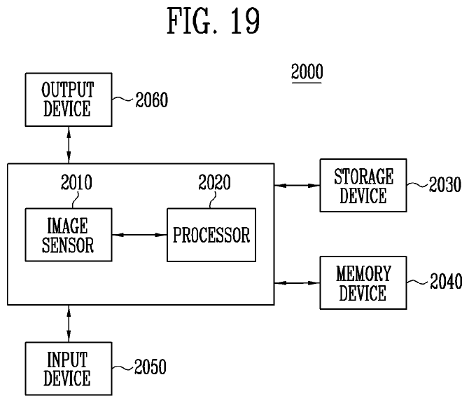

FIG. 19 is a block diagram illustrating an electronic device including an image processing device according to an embodiment of the present disclosure.

Referring to FIG. 19, the electronic device 2000 may include an image sensor 2010, a processor 2020, a storage device 2030, a memory device 2040, an input device 2050, and an output device 2060. Although not shown in FIG. 19, the electronic device 2000 may further include ports capable of communicating with a video card, a sound card, a memory card, a USB device, or the like, or communicating with other electronic devices.

The image sensor 2010 may generate image data corresponding to incident light. The image data may be transmitted to and processed by the processor 2020, The image sensor 2010 may generate the image data for an object input (or captured) through a lens. The lens may include at least one lens forming an optical system.

The image sensor 2010 may include a plurality of pixels. The image sensor 2010 may generate a plurality of pixel values corresponding to the captured image in a plurality of pixels. The plurality of pixel values that are generated by the image sensor 2010 may be transmitted to the processor 2020 as pixel data. That is, the image sensor 2010 may generate the plurality of pixel values corresponding to a single frame.

The output device 2060 may display the image data. The storage device 2030 may store the image data. The processor 2020 may control operations of the image sensor 2010, the input device 2050, the output device 2060, and the storage device 2030.

The processor 2020 may be an image processing device that performs an operation of processing the pixel data received from the image sensor 2010 and outputs the processed image data, Here, the processing may be electronic image stabilization (EIS), interpolation, color tone correction, image quality correction, size adjustment, or the like.

In an embodiment of the present disclosure, the processor 2020 may parallelize the received pixel data, store the parallelized pixel data in line memories, and read interpolation data for performing a distortion interpolation operation based on coordinate information of a distortion pixel from the line memories. The processor 2020 may read the interpolation data from the line memories based on a horizontal coordinate and a vertical coordinate indicating a position in which the interpolation data is stored and may perform the distortion interpolation operation. The processor 2020 may perform a demosaicing operation only on the interpolation data and may reduce a logic scale by performing an operation of changing pixel data for a green pixel to pixel data for a red pixel or a blue pixel in the same method.

The processor 2020 may be implemented as a chip independent of the image sensor 2010. For example, the processor 2020 may be implemented as a multi-chip package. In another embodiment of the present disclosure, the processor 2020 may be included as a part of the image sensor 2010 and implemented as a single chip.

The processor 2020 may execute and control an operation of the electronic device 2000. According to an embodiment of the present disclosure, the processor 2020 may be a microprocessor, a central processing unit (CPU), or an application processor (AP). The processor 2020 may be connected to the storage device 2030, the memory device 2040, the input device 2050, and the output device 2060 through an address bus, a control bus, and a data bus to perform communication.

The storage device 2030 may include a flash memory device, a solid state drive (SSD), a hard disk drive (HDD), a CD-ROM, all types of nonvolatile memory devices, and the like.

The memory device 2040 may store data that are necessary for the operation of the electronic device 2000. For example, the memory device 2040 may include a volatile memory device, such as a dynamic random access memory (DRAM) and a static random access memory (SRAM), and a nonvolatile memory device such as an erasable programmable read-only memory (EPROM), an electrically erasable programmable read-only memory (EEPROM), and a flash memory device. The processor 2020 may execute a command set stored in the memory device 2040 to control the image sensor 2010, the input device 2050, and the output device 2060.

The input device 2050 may include an input means, such as a keyboard, a keypad, and a mouse, and the like. The output device 2060 may include an output means, such as a printer and a display.

The image sensor 2010 may be implemented in various types of packages. For example, at least some configurations of the image sensor 2010 may be implemented using packages, such as a package on package (PoP), ball grid arrays (BGAs), chip scale packages (CSPs), plastic leaded chip carrier (PICC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline integrated circuit (SOIC), shrink small outline package (SSCP), thin small outline package (TSOP), system in package (SIP), multi-chip package (MCP), wafer-level fabricated package (WFP), wafer-level processed stack package (WSP), and the like.

Meanwhile, the electronic device 2000 may be interpreted as all computing systems that use the image sensor 2010. The electronic device 2000 may be implemented in a form of a packaged module, a part, or the like. For example, the electronic device 2000 may be implemented as a digital camera, a mobile device, a smart phone, a personal computer (PC), a tablet personal computer (PC), a notebook, a personal digital assistant (PDA), an enterprise digital assistant (EDA), a portable multimedia player (PMP), a wearable device, a black box, a robot, an autonomous vehicle, and the like.

Since the present disclosure may be implemented in other specific forms without changing the technical spirit or essential features thereof, those of ordinary skill in the art to which the present disclosure pertains should understand that the embodiments described above are illustrative and are not limited in all aspects. The scope of the present disclosure is indicated by the claims to be described later rather than the detailed description, and all changes or modifications derived from the meaning and scope of the claims and their equivalent concepts are interpreted as being included in the scope of the present disclosure.

What is claimed is:

1. An image processing device comprising:
a buffer configured to parallelize pixel data of an image that is received from an external device based on the number of horizontal direction pixels that are used for a distortion interpolation operation and configured to store the parallelized pixel data in line memories; and
a distortion interpolator configured to read interpolation data among the pixel data that are stored in the line memories, based on coordinate information of a target pixel, which is a distorted pixel, and configured to perform the distortion interpolation operation based on the interpolation data.

2. The image processing device of claim 1, wherein the buffer comprises the line memories, and
wherein the number of line memories exceeds an addition of twice the maximum number of distortion lines of the image and half the number of lines that are used for the distortion interpolation operation.

3. The image processing device of claim 2, wherein the buffer determines a pixel unit that is stored in the line memories based on the number of horizontal direction pixels and sequentially stores the pixel data in the line memories according to the pixel unit.

4. The image processing device of claim 3, wherein, in response to all of the line memories being full, the buffer stores additional data in a line memory having oldest data, among the line memories.

5. The image processing device of claim 4, wherein the distortion interpolator further comprises a starter configured to generate a start signal that triggers the distortion interpolation operation based on an amount of data that is stored in the line memories.

6. The image processing device of claim 5, wherein the starter outputs the start signal in response to the number of line memories that are storing the pixel data being equal to the addition of twice the maximum number of distortion lines related to the target pixel and half the number of lines used for the distortion interpolation operation.

7. The image processing device of claim 6, wherein the start signal includes coordinate information of the target pixel.

8. The image processing device of claim 5, wherein the distortion interpolator further comprises a buffer reader configured to receive the start signal and generate position information indicating a position of the interpolation data that are stored in the line memories based on a display coordinate of the target pixel and a distortion coordinate of the target pixel.

9. The image processing device of claim 8, wherein the position information includes a vertical coordinate indicating a line memory, among the line memories, in which the interpolation data is stored and a horizontal coordinate indicating a horizontal direction coordinate in which the interpolation data is stored in the line memory.

10. The image processing device of claim 9, wherein the horizontal coordinate includes a first horizontal coordinate indicating a horizontal direction coordinate of the target pixel and a second horizontal coordinate indicating a position for storing pixel data for the target pixel, among pixel data for a plurality of pixels that are stored in the first horizontal coordinate, according to the pixel unit in the line memory.

11. The image processing device of claim 10, wherein the buffer reader generates read data including pixel data of which a horizontal direction coordinate is the same as the interpolation data from each of the line memories based on the first horizontal coordinate.

12. The image processing device of claim 11, wherein the read data includes pixel data for a plurality of pixels that are stored at a position that is indicated by the first horizontal coordinate and a coordinate adjacent to the first horizontal coordinate.

13. The image processing device of claim 11, wherein the buffer reader obtains intermediate data corresponding to the vertical coordinate from the read data.

14. The image processing device of claim 13, wherein the intermediate data includes read data that are stored in line memories that are indicated by the vertical coordinate and a coordinate adjacent to the vertical coordinate among the read data.

15. The image processing device of claim 13, wherein the buffer reader selects the interpolation data from the intermediate data based on the second horizontal coordinate and outputs the interpolation data.

16. The image processing device of claim 15, wherein the interpolation data includes pixel data for pixels that are indicated by the second horizontal coordinate and a coordinate adjacent to the second horizontal coordinate among the intermediate data.

17. The image processing device of claim 8, further comprising:
a dock signal manager configured to apply a first dock signal that is used for the distortion interpolation operation to the distortion interpolator and apply a second dock signal that is at least two times faster than the first clock signal to the buffer.

18. The image processing device of claim 17, wherein the dock signal manager comprises a first clock converter configured to increase a speed of the first clock signal by a speed of the second clock signal, and
wherein the first clock converter increases a clock speed for the position information.

19. The image processing device of claim 18, wherein the clock signal manager further comprises a second clock converter configured to decrease the speed of the second clock signal by the speed of the first clock signal, and
wherein the second dock converter decreases a dock speed for the interpolation data.

20. The image processing device of claim 8, wherein the buffer reader generates weighted value information that is used for the distortion interpolation operation based on a distortion value indicating a difference between the display coordinate of the target pixel and the distortion coordinate of the target pixel, and
wherein the distortion interpolator corrects a result of the distortion interpolation operation based on the weighted value information.

21. The image processing device of claim 20, wherein the buffer reader generates the position information based on an integer part of the distortion value and generates the weighted value information based on a fractional part of the distortion value.

22. The image processing device of claim 20, wherein the buffer reader delays an output of the weighted value information and outputs the weighted value information at the same timing as the interpolation data.

23. The image processing device of claim 8, wherein the distortion interpolator further comprises a demosaicing component configured to determine a color of pixels of the interpolation data based on the display coordinate and the position information and configured to change pixel data for a position of pixels having a color that is different from a color of the target pixel to pixel data of pixels having a color the same as the target pixel.

24. The image processing device of claim 23, wherein the demosaicing component comprises a first demosaicing component configured to change pixel data for a red pixel or blue pixel to pixel data for a green pixel, and a second demosaicing component configured to change the pixel data for the green pixel to the pixel data for the red pixel or the blue pixel.

25. An Image processing method comprising:
storing pixel data in line memories, the pixel data parallelized based on a pixel unit that is determined according to the number of horizontal direction pixels of a line memory;
reading interpolation data that are used for a distortion interpolation operation, among the pixel data that are stored in the line memories, based on coordinate information of a target pixel, which is a distorted pixel; and
performing the distortion interpolation operation based on the interpolation data.

26. The image processing method of claim 25, wherein storing the pixel data in the line memories comprises:
generating a start signal that triggers the distortion interpolation operation based on an amount of data that is stored in the line memories; and
generating, in response to the start signal, position information indicating a position of the interpolation data that are stored in the line memories based on a display coordinate of the target pixel and a distortion coordinate of the target pixel.

27. The image processing method of claim 25, wherein reading the interpolation data comprises:
generating read data including pixel data of which a horizontal direction coordinate is the same as the interpolation data from each of the line memories based on a first horizontal coordinate indicating a horizontal direction coordinate of the target pixel;
obtaining intermediate data corresponding to a vertical coordinate indicating a line memory in which the interpolation data is stored among the line memories from the read data; and
outputting the interpolation data from the intermediate data based on a second horizontal coordinate indicating a position at which pixel data for the target pixel is stored, among pixel data for a plurality of pixels that are stored in the first horizontal coordinate.

28. The image processing method of claim 27, wherein reading the interpolation data further comprises:
generating weighted value information that is used for the distortion interpolation operation based on a distortion value indicating a difference between the display coordinate of the target pixel and the distortion coordinate of the target pixel; and
outputting the weighted value information at the same timing as the interpolation data.
